(19) United States
(12) Patent Application Publication
(10) Pub. No.: US 2011/0079211 A1
(43) Pub. Date: Apr. 7, 2011

(54) Burner Assembly with Rocker Panel

(76) Inventor: Adrian A. Bruno, Rolling Meadows, IL (US)

(21) Appl. No.: 12/573,307

(22) Filed: Oct. 5, 2009

(51) Int. Cl. F24C 3/08; A47J 37/07

(52) U.S. Cl. 126/39 E; 126/25 R

(57) ABSTRACT

Disclosed herein is an embodiment of a cover for a barbecue grill side burner assembly. The cover is defined by a top wall and side walls which depend from the perimeter of the top wall. The side walls are provided with a contoured lower edge that define a fulcrum for the cover. The burner assembly includes a recessed portion with a ledge extending about its perimeter. The cover is supported within the recessed portion by the side walls, which sit on the ledge, whereby the top wall of the cover is approximately flush with the top surface of the burner assembly housing. The cover can be removed by pressing on a portion of the cover on one side of the fulcrum. This causes the portion of the cover on the opposite side of the fulcrum to emerge from the recessed portion whereby the cover can be gripped and removed from the burner assembly.

### CROSS-REFERENCE TO RELATED APPLICATIONS

Not Applicable.

### STATEMENT REGARDING FEDERALLY SPONSORED RESEARCH OR DEVELOPMENT

Not Applicable.

### THE NAMES OF PARTIES TO A JOINT RESEARCH AGREEMENT

Not Applicable.

### INCORPORATION-BY-REFERENCE OF MATERIAL SUBMITTED ON A COMPACT DISC

Not Applicable.

### BACKGROUND OF THE INVENTION

1. Technical Field

The embodiments described and claimed herein relate generally to a cooking apparatus. More specifically, the embodiments relate to a removable cover for a burner assembly for a barbecue grill.

2. Background Art

Burner assemblies for barbecue grills often include a cover that protects the burner from the elements and keeps the burner clean when not in use. These burner assemblies use hardware such as handles and/or finger holes to allow the cover to be moved away from the cooking surface of the burner assembly. One problem with existing burner assemblies is that the handles/finger holes present a negative effect on the overall appearance of the burner assembly. An additional aesthetic and functional hindrance is that some burner covers are connected to the burner by a hinge. The hinge presents additional cost and limits the amount of space for cooking and creates inconveniences. These inconveniences include, but are not limited to falling covers that can be extremely dangerous, particularly when the burner has reached high temperatures.

### BRIEF SUMMARY OF THE INVENTION

The embodiments of a new cover detailed herein resolves at least some of the shortcomings associated with previous burner assemblies. The cover of the burner is improved so that it sits within a recessed portion of the burner assembly with its top surface generally flush with the housing of the burner assembly. In that respect, the cover resembles the surface of the burner's housing, giving the assembled burner a complete aesthetically appealing appearance. In order to have an aesthetically clean surface, the top wall of the rocker panel is provided with contoured side walls which depend from the top wall. These contoured side walls provide a stable platform for the cover, while at the same time enabling the cover to pivot about an axis that is parallel to the cooking surface of the burner. When pressure is applied to a portion of the top surface on one side of the pivot axis, the portion of the cover on the opposite side of the pivot axis emerges from the recessed portion of the burner assembly housing and allows the rocker panel to be easily gripped and removed from the burner. For this reason, the cover is also referred to herein as a rocker panel.

### BRIEF DESCRIPTION OF THE SEVERAL VIEWS OF THE DRAWINGS

These and other features, aspects, objects, and advantages of the embodiments described and claimed herein will become better understood upon consideration of the following detailed description, appended claims, and accompanying drawings where:

FIG. 1 is a perspective view of a burner assembly with a removable cover; and,

FIG. 2 is a working view of the same.

It should be understood that the drawings are not necessarily to scale and that the embodiments are sometimes illustrated by graphic symbols, phantom lines, diagrammatic representations and fragmentary views. In certain instances, details which are not necessary for an understanding of the embodiments described and claimed herein or which render other details difficult to perceive may have been omitted. It should be understood, of course, that the inventions described herein are not necessarily limited to the particular embodiments illustrated. Indeed, it is expected that persons of ordinary skill in the art may devise a number of alternative configurations that are similar and equivalent to the embodiments shown and described herein without departing from the spirit and scope of the claims.

Like reference numerals will be used to refer to like or similar parts from figure to figure in the following detailed description of the drawings.

### DETAILED DESCRIPTION OF THE INVENTIONS

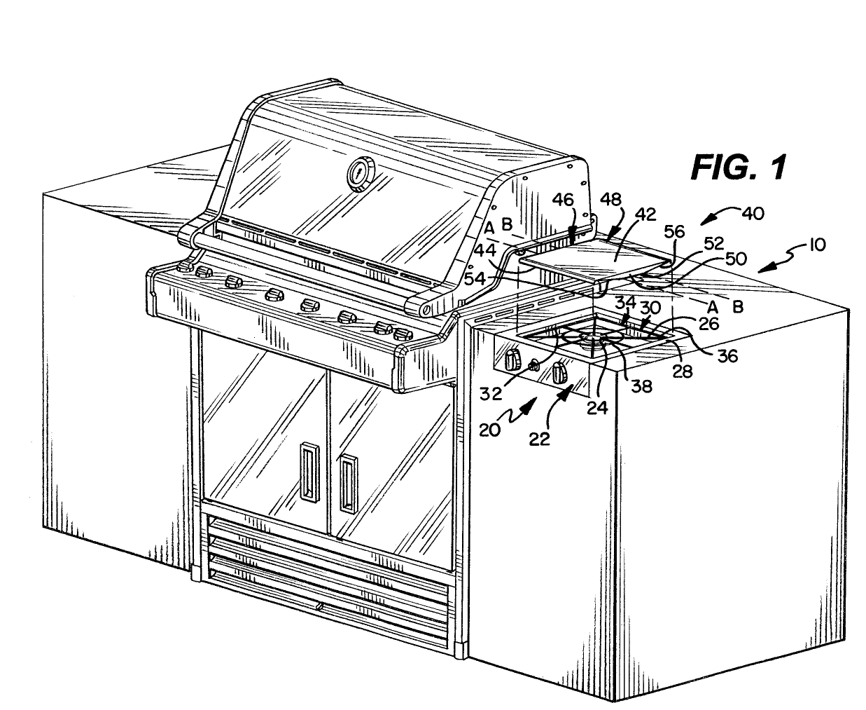

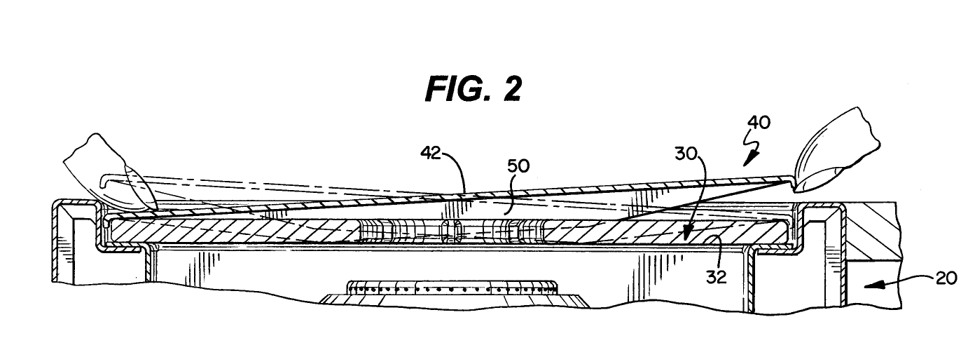

One embodiment of a burner assembly 10 is shown in FIGS. 1-2. In this embodiment, the burner assembly generally comprises a base burner 20 and a rocker panel/cover 40. Although shown as a separate assembly for a built-in barbecue grill, it is contemplated that the burner assembly 10 can be modified for use as a side shelf assembly for a free-standing barbecue grill.

With particular reference to FIG. 1, the base burner 20 includes a housing 22 which holds a burner 24 and a cooking grate 26. The cooking grate 26 sits below a top surface 28 of the housing 22 in a recessed portion 30. The shown cooking grate 26 is invertible. In its shown configuration, the cooking grate 26 can be used with flat bottomed cooking utensils. In its inverted position, prongs 38 extend upward to support a curved bottom cooking utensil, like a wok. The recessed portion 30 of the housing 22 is characterized by a ledge 32 that extends about the perimeter of the recessed portion 30 and supports the cooking grate 26. The width and/or length of the cooking grate 26 are slightly smaller than the corresponding dimensions of the recessed portion 30, whereby a channel 34 is formed at least partly surrounding the cooking grate 26. The grate 26 and ledge 32 may be provided positioning features, such as projections 36 on the cooking grate 26 and corresponding indentations (not shown) on the ledge 32, to ensure the cooking grate 26 is centered within the recessed portion 30. As is discussed in greater detail below, the channel 34 is configured to receive a portion of the rocker panel 40, whereby the rocker panel rests above the grate, thereby protecting the burner assembly 10 from any possible exposure to the elements, such as rain and snow, which may damage the burner assembly 10.

The rocker panel 40 has a top wall 42 and a plurality of segmented walls 44, 46, 48, 50 which depend from the perimeter of the top wall 42. When the rocker panel 40 is appropriately positioned on the base burner 20, the segmented walls 44, 46, 48, 50 are received within the channel 34 whereby the top wall 42 of the rocker panel 40 is approximately flush with the top surface 28 of the housing 22 of the base burner 20.

At least one of the segmented walls 44, 46, 48, 50 is contoured to include a fulcrum that allows the rocker panel 40 to pivot about an axis A or B that is parallel to the surface of the base burner 20. In the shown embodiment, wall 48 is the same as wall 44, and wall 46 is the same as wall 50. In particular, segmented walls 46, 50 have a contour that is best described as an inverted isosceles trapezoid, with a bottom edge 52, and two angled edges 54, 56. The intersections of the bottom edge 52 and the two angled edges 54, 56 serve as the fulcrums for the rocker panel 40. The bottom edge 52 is generally parallel to the top wall 42 of the rocker panel 40. When the rocker panel 40 is sitting undisturbed in the base burner 20 above the cooking grate 26, the bottom edge 52 of the rocker panel 40 supports the rocker panel 40 in a stable position parallel to the top surface 28 of the base burner 20. As best demonstrated by FIG. 2, the two angled edges 54, 56 allow the rocker panel 40 to be rocked in either direction about axis A or B. More specifically, and as is best shown by FIG. 2, when pressure is applied to a portion of the top wall 42 of the rocker panel 40 on one side of the axis A or B, the bottom edge 52 of the rocker panel 40 lifts away from the ledge 32 of the base burner, whereby the portion of the top wall 42 on the opposite side of the axis A or B will emerge from the recessed portion 30 of the housing 22 of the base burner 20, enabling the rocker panel 40 to be removed with ease.

The segmented walls 44, 46, 48, 50 can be provided with other contours that would provide similar results. For example, the segmented walls could be provided with a parabolic or curvilinear bottom edge.

Although the inventions described and claimed herein have been described in considerable detail with reference to certain embodiments, one skilled in the art will appreciate that the inventions described and claimed herein can be practiced by other than those embodiments, which have been presented for purposes of illustration and not of limitation. Therefore, the spirit and scope of the appended claims should not be limited to the description of the embodiments contained herein.

I claim:

1. A burner assembly for a barbecue grill comprising:
a rocker panel and a base burner;
said rocker panel having a top wall and at least one wall depending from a perimeter of the top wall;
the base burner including a recessed portion which receives the at least one wall of the rocker panel, whereby the top wall of the rocker panel is approximately flush with a top surface of the base burner;
at least a portion of the at least one wall having a contoured lower edge with at least one fulcrum, whereby, when downward pressure is applied to a first portion of the top wall of the rocker panel, the rocker panel pivots and a second portion of the top wall of the rocker panel emerges from the recessed portion of the base burner, thereby allowing a user to grasp and remove the rocker panel.

2. The burner assembly of claim 1, wherein the base burner includes a ledge positioned within the recessed portion for supporting both a cooking grate and the rocker panel.

3. The burner assembly of claim 2, wherein the ledge and the rocker panel include positioning features that locate the cooking grate at the center of the recessed portion of the base burner.

4. The burner assembly of claim 2, wherein the inner dimensions of the recessed portion exceed those of the cooking grate, whereby a channel is formed between a perimeter of the cooking grate and the base burner, the channel configured to receive the at least one wall of the rocker panel.

5. The burner assembly of claim 4, wherein the contoured lower edge of the at least one wall sits within the channel and rests upon the ledge, the at least one wall having a height which exceeds a thickness of the cooking grate, such that the top wall of the rocker panel is vertically spaced from the cooking grate.

6. The burner assembly of claim 5, wherein the contoured lower edge of the at least one wall resembles an inverted isosceles triangle, including a bottom edge and two angled side edges, the bottom edge of the at least one wall being generally parallel to the top wall of the rocker panel, the two angled side edges allowing the rocker panel to be pivoted in two directions.
